(19) United States
(12) Patent Application Publication
(10) Pub. No.: US 2014/0085422 A1
(43) Pub. Date: Mar. 27, 2014

(54) IMAGE PROCESSING METHOD AND DEVICE

(71) Applicants: Pär-Anders Aronsson, Malmö (SE); Martin Ek, Dalby (SE); Magnus Jendbro, Staffanstorp (SE); Magnus Landqvist, Lund (SE); Pär Stenberg, Veberöd (SE); Ola Thörn, Limhamn (SE)

(72) Inventors: Pär-Anders Aronsson, Malmö (SE); Martin Ek, Dalby (SE); Magnus Jendbro, Staffanstorp (SE); Magnus Landqvist, Lund (SE); Pär Stenberg, Veberöd (SE); Ola Thörn, Limhamn (SE)

(73) Assignee: SONY ERICSSON MOBILE COMMUNICATIONS AB, Lund (SE)

(21) Appl. No.: 13/512,137

(22) PCT Filed: May 30, 2011
(86) PCT No.: PCT/EP11/02674

§ 371 Date: May 25, 2012

(51) Int. Cl. H04N 13/02

(52) U.S. Cl. CPC H04N 13/0257
USPC 348/46

(57) ABSTRACT

Methods and devices (20) are provided which provide, for example capture with a camera (22, 23), at least one intermediate image of a scene. Colors of the at least one intermediate image are modified based on depth information (210, 28), and a final image is provided based on the at least one intermediate image with modified colors.

### TECHNICAL FIELD

The present application relates to methods and devices involving image processing. In particular, some embodiments relate to enhancing a three-dimensional appearance of a two-dimensional image.

### BACKGROUND

With the development of image sensors, digital photography, i.e. a digital capturing of images, has become more and more popular and has at least in the consumer sector largely replaced analog photography using films. The possibility of capturing digital images is not only provided by dedicated camera equipment, but digital cameras are integrated in many mobile devices, for example mobile phones, laptop computers, tablet PC's or mobile gaming devices. Digital images give vise to the possibility of digital image processing, i.e. modifying captured images. Image processing techniques commonly include e.g. white balance adjustment or sharpening of images.

Furthermore, in recent years three-dimensional imaging has become more and more popular. For three-dimensional images, two images of the same scene with different viewing angles are captured, and then the “three-dimensional picture” may be viewed with special viewing devices, for example headsets involving polarizers or shutters. However, still most viewing devices are only adapted for displaying two-dimensional images, e.g. simple display screens.

It would therefore be desirable to also enhance a three-dimensional appearance of two-dimensional images, or, in other words, to provide possibilities for adding or enhancing a three-dimensional impression also in conventional two-dimensional images.

### SUMMARY

According to an embodiment, a method as defined in claim 1 is provided. According to a further embodiment, a device as defined in claim 11 is provided. The dependent claims define further embodiments.

According to an embodiment, a method is provided, comprising:
providing at least one intermediate image of a scene,
providing depth information of the scene,
modifying colors of the at least one intermediate image based on the depth information, and
providing a final image based on the at least one intermediate image with modified colors.

According to an embodiment, modifying colors of the at least one intermediate image may comprise reducing colors of portions of the at least one intermediate image further away from a viewer relative to the colors of portions of the at least one intermediate image closer to a viewer.

According to an embodiment, modifying the colors may comprise enhancing colors of portions of the at least one intermediate image closer to a viewer relative to colors of portions of the at least one intermediate image farther away from a viewer.

According to an embodiment, providing depth information of the scene may comprise scanning the scene with a depth scanner.

According to an embodiment, providing at least one intermediate image of the scene and providing depth information of the scene may comprise capturing at least two intermediate images of the scene with different focus distances, the depth information comprising the focus distances.

According to an embodiment, providing the final image may comprise combining the at least two intermediate images with modified colors.

According to an embodiment, combining the at least two intermediate images may comprise focus stacking.

According to an embodiment, modifying the colors may comprise reducing the colors of an intermediate image of the at least two intermediate images with a greater focus distance relative to the colors of an intermediate image of the at least two intermediate images with a smaller focus distance.

According to an embodiment, modifying the colors may comprise enhancing the colors of an intermediate image of the at least two intermediate images with a greater focus distance relative to the colors of an intermediate image of the at least two intermediate images with a smaller focus distance.

According to an embodiment, capturing the at least two intermediate images may comprise capturing the at least two intermediate images with at least two different cameras (22, 23).

According to a further embodiment, a device is provided, comprising:
at least one camera configured to provide an image of a scene (25; 26), and
a processor unit configured to modify colors of the at least one intermediate image based on depth information of the scene, and to provide a final image based on the at least one intermediate image with modified colors.

According to an embodiment, the device may further comprise a depth scanner configured to provide said depth information.

According to an embodiment, the device may be configured to capture at least two intermediate images of the scene with said camera with different focus distances, the depth information comprising the focus distances.

According to an embodiment, the device may be selected from the group consisting of a mobile phone, a digital camera, a laptop computer, a tablet PC, and a gaming device.

The device, in particular the processor unit thereof, may be configured to execute any of the above-explained methods, for example by programming the processor unit accordingly.

The above-described embodiments may be combined with each other unless noted otherwise.

In some embodiments, through modifying the colors a three-dimensional appearance of the final image may be enhanced.

### BRIEF DESCRIPTION OF THE DRAWINGS

Non-limiting embodiments of the invention will be described with reference to the attached drawings, wherein:

FIG. 1 is a flowchart representing a method according to an embodiment,

FIG. 2 is a block diagram illustrating a device according to an embodiment, and

FIG. 3 is a block diagram illustrating a device according to another embodiment.

### DETAILED DESCRIPTION

In the following, embodiments of the present invention will be described with reference to the attached drawings. It should be noted that these embodiments are merely given to illustrate possibilities for implementing the present invention and are not to be construed as limiting. Features of different embodiments described may be combined with each other unless specifically noted otherwise. On the other hand, describing an embodiment with a plurality of features is not to be construed as indicating that all those features are necessary for practicing the invention, as other embodiments may comprise less features or alternative features.

In general, embodiments described to the following relate to capturing an image. Capturing images may comprise capturing still images, capturing movies (which amount to a quick succession of images), or both.

Usually, for capturing images digital cameras are used, although images may also be obtained from other sources like film scanning. Digital cameras, as known in the art, comprise some optics, in particular comprising lenses, for focussing light on an image sensor, which image sensor then captures the image. Image sensors may comprise CCD (Charge Coupled Device)-Sensors or CMOS-Sensors, both of which may have a color filter placed in front of the sensor to be able to capture colored images, or may also comprise image sensors having multiple layers for capturing different colors. The optic provided may be a fixed focus or a variable focus optic. Fixed focus optics have a fixed focus plane, which corresponds to the plane in an image which appears “sharpest” on the image, while with variable focus optics the focus may be adjusted between different distances. The distance between the camera and the focus plane is referred to a focus distance in the following. It should be noted that these terms are not to be confused with the term focal length or focal plane, which also depends on the optic used and which determines the angle of view of the optic and therefore of the camera. The optic may have a fixed focal length, for example be a so called prime lens, or may also have a variable focal length, i.e. may comprise a so called zoom lens.

Embodiments described in the following relate to modifying colors of images. This is construed not to cover only modifying colors of colored images, but is construed also to cover the modifying of colors of monochrome images, for example the greyscales of black and white images.

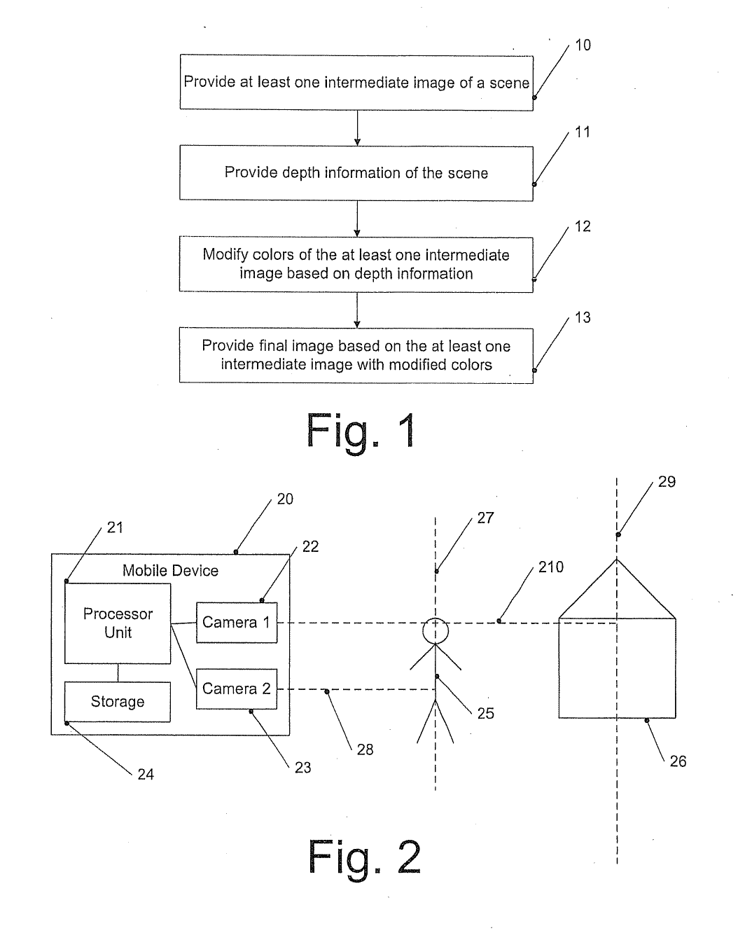

Turning now to the Figures, in FIG. 1 a flowchart representing an embodiment of a method is shown.

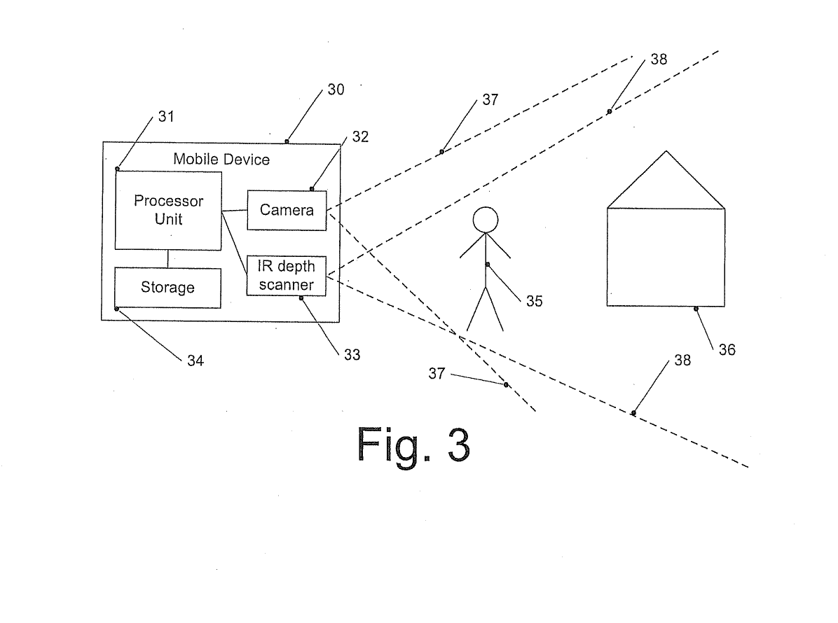

In the method of FIG. 1, at 30 at least one intermediate image of a scene is provided. As will be explained with reference to FIG. 2 in more detail, in some embodiments a single intermediate image of the scene may be provided, or in other embodiments two or more intermediate images are provided, the two or more intermediate images in some embodiments been taken with different focus distances. The label intermediate indicates that the image will be further processed, as will be explained below.

At 11, depth information for the scene is provided. For example, information as regards distances between a viewer and certain portions of the scene may be provided. In some, embodiments, as also will be explained further below a depth information may be obtained by a depth analyzing device, for example an infrared scanning device. In other embodiments where two or more images are captured with different focus distances, the depth information may comprise or consist of the different focus distances, the focus distances indicating the distances between a viewer and a focus plane of the respective intermediate image.

As can be seen from the example where the focus distance is at least part of the depth information, the actions at 10 and 11 may be performed simultaneously, or consecutively in any desired order. For example, the depth information may be provided before or after providing the at least one intermediate image.

At 12, colors of the at least one intermediate image are modified based on the depth information. For example, in case the at least one intermediate image comprises a single image, portions of the image which according to the depth information are farther away from a viewer may have their color reduced, for example by decreasing a color intensity or a brightness, and/or portions of the image closer to a viewer may have their color enhanced, for example by enhancing the color intensity and/or enhancing the brightness. Through such a modification, in some embodiments a three-dimensional appearance may be created, as it corresponds to natural seeing to see things farther away with less vivid colors.

In case the at least one intermediate image comprises a plurality of images, intermediate images with a greater focus distance may have their color reduced, and/or intermediate images with a smaller focus distance may have their color enhanced. The above approaches may also be combined for example in cases where more than one intermediate image of a scene is taken and the depth information comprises both the focus distances and depth information provided by a further source like an IR scanner.

Finally, at 13 a final image is provided based on the at least one intermediate image with modified colors. In case only one intermediate image is used, the final image may be identical to the at least one intermediate image with modified colors, or some image processing may be applied, for example a sharpening algorithm. In case the at least one intermediate image comprises two or more intermediate images captured at different focus distances, the final image may be based on a combination of the intermediate images. In particular, in some embodiments, the intermediate images may be combined with a technique known as focus stacking, which is a conventional technique for combining images taken at different focus distances and which is conventionally used to provide a resulting image with a greater depth of field. Also in this case, when combining the plurality of intermediate images with the colors modified as explained above, i.e. colors of images with greater focus distances reduced compared to the colors of images with smaller focus distances, a three-dimensional appearance of the final image may be enhanced. It should be noted that also in this case further conventional image processing techniques may be applied like sharpening in addition to the combination via focus stacking.

Embodiments of devices in which the method of FIG. 1 may be implemented will next be discussed with reference to FIGS. 2 and 3. The embodiment of FIG. 2 is an example for an embodiment usable for capturing and processing a plurality of intermediate images having different focus distances, while the embodiment of FIG. 3 is an example for a device usable with a single intermediate image and additional depth information. As already indicated above, features of the two embodiments may be combined for providing a device capturing a plurality of images with different focus distances and providing additional depth information.

In FIG. 2, an embodiment of a device 20 is schematically shown. In the embodiment of FIG. 2, device 20 is a mobile device, for example a dedicated camera, a mobile phone incorporating cameras, a laptop computer incorporating cameras, a tablet PC, a gaming device or any other suitable mobile device.

The device of FIG. 2 comprises a first camera 22 and a second camera 23. Each of cameras 22, 23 may comprise an optic, in particular a lens optic, and an image sensor. First camera 22 and second camera 23 in the embodiment are arranged to capture an image of essentially the same scene, but with different focus distances.

As a simple example of a scene, in FIG. 2 a scene comprising a person 25 and a building 26 is shown. In the example of FIG. 2, both first camera 22 and second camera 23 capture the complete scene comprising person 25 and building 26, although in some cases slight deviations may be possible. However, in the example shown in FIG. 2 first camera 22 is focused on building 26, i.e. a focus plane 29 of first camera 22 is located at building 26 or, in other words, first camera 22 is adjusted to a focus distance 210. On the other hand, second camera 23 is focused on person 25, i.e. a focus plane 27 of second camera 23 runs through person 25, corresponding to a focus distance 28 of second camera 23 which is shorter than focus distance 210 of first camera 22.

It should be noted that the focus plan 29, 27 and the focus distances 210, 28 shown in FIG. 2 serve only as examples, and the focus distances of first camera 22 and second camera 23 may be set to any distance desired for a particular scene, in the example of FIG. 2 for example also to distances in front of person 25 (i.e. shorter than focus distance 28), between person 25 and building 26 or also behind building 26 (i.e. greater than focus distance 210).

Images captured by first camera 22 and second camera 23 are examples for intermediate images of the embodiment of FIG. 1, and the focus distances 28, 210 as already mentioned are examples for depth information.

First camera 22 and second camera 23 are coupled with a processor unit 21. Processor unit 21 may comprise one or more microprocessors like general purpose microprocessors or digital signal processors configured, for example programmed, to process images captured by first camera 22 and second camera 23. Processor unit 21 is also coupled to a storage 24, for example a random access memory (RAM), a flash memory, a solid state disk, and/or a rewritable optical medium and my store images captured by first camera 22 and second camera 23 in storage 24.

Processor unit 21 in the embodiment of FIG. 2 is further configured to modify colors of the images captured by first camera 22 and second camera 23 based on the focus distances and to provide a final image based on the color modified images, for example by combining the color modified images with the above-mentioned focus stacking. For example, processor unit 21 may reduce the colors of an image with a greater focus distance, in the example of FIG. 2 the image captured by first camera 22, compared to an image captured with a smaller focus distance, in the example of FIG. 2 the image captured by second camera 23. This may be done by reducing the colors of the image captured at the larger focus distance, by enhancing the colors of the image captured at the shorter focus distance, or both. The resulting final image may be stored in storage 24.

It should be noted that the device 20 shown in FIG. 2 is merely one example for capturing images with different focus distances. In another embodiment, more than two cameras may be provided to capture more than two images with different focus differences simultaneously. On the other hand, the images may also be taken consecutively. For example, a device with a single camera, for example only camera 22, may be provided, and being configured such that the single camera captures two or more images of the same scene with varying focus distances. The above variations may also be combined, for example in the embodiment of FIG. 2 each of first camera 22 and second camera 23 may capture two or more images with different focus distances, and then all the images captured by first camera 22 and second camera 23 of the same scene may be combined and have their colors modified as described above.

A further device according to an embodiment is shown in FIG. 3. Device 30 in FIG. 3 is a mobile device similar as device 20 of FIG. 2 and, as device 20, may for example be a dedicated camera, a mobile phone, a laptop computer, a tablet PC or a portable gaming device. Mobile device 30 of the embodiment of FIG. 3 comprises a camera 32 for capturing an image of a scene and an IR depth scanner 33 for determining distances in the scene. As an example scene, again a scene comprising a person 35 and a building 36 is shown. As indicated by dashed lines 37, camera 32 captures an image of the scene. Furthermore, as indicated by dashed lines 38 IR depth scanner 33 scans the scene to determine a depth distribution of the scene, i.e. determine the distance of various elements in the scene like person 35 or building 36 from mobile device 30. To this end, IR depth scanner 33 may comprise an infrared (IR) light source which scans the scene. A reference portion of the emitted IR light may interfere with IR light reflected from the scene, and based on the interference the above described depth distribution may be obtained. The scanning of the scene by IR depth scanner may be performed before, while or after capturing the image of the scene by camera 32. A processor unit 31 of mobile device 30 and a storage 34 of mobile device 30 may generally be implemented in a similar manner processor unit 21 and storage 24 of the embodiment of FIG. 2. In the embodiment of FIG. 3, processor unit 31 is configured to receive an image captured by camera 32 and the corresponding depth information, i.e. distribution of the scene from IR depth scanner 33 and modify the colors of the captured image based on the depth information. For example, portions of the image corresponding to portions of the scene farther away from a viewer, i.e. from camera 32 of mobile device 30, may have their color reduced compared to portions of the scene closer to the viewer, i.e. closer to camera 32 of mobile device 30. For example, in the example scene shown in FIG. 3 building 36 may have its colors reduced compared to person 35.

This may be achieved by reducing the colors of the portions farther away from the viewer enhancing the colors of the portions closer to the viewer or both. Different distances or different zones of distances may be assigned different color enhancements/reductions. The thus modified image, possibly together with the original image captured, may be stored in storage 34.

It should be noted that mobile devices 20 and 30 of FIGS. 2 and 3 are depicted as having some components like processor unit, camera etc. serving to explain the respective embodiments. Mobile devices 20 and 30 may comprise further components, for example components unrelated to these explanations, which are not shown, like batteries for supplying the components with power, input keys and displays for allowing a user interaction, etc., or also components for implementing other functions, like components for coupling with a telecommunication network in case for example of mobile phones.

As already explained above, a plurality of variations and combinations are available with the above-described embodiments, which therefore are not to be construed as limiting the scope of the present application in any way.

1-15. (canceled)

16. A method, comprising:
providing at least one intermediate image of a scene,
providing depth information of the scene,
modifying colors of the at least one intermediate image based on the depth information, and
providing a final image based on the at least one intermediate image with modified colors.

17. The method of claim 16, wherein modifying colors of the at least one intermediate image comprises reducing color of portions of the at least one intermediate image further away from a viewer relative to the colors of portions of the at least one intermediate image closer to a viewer.

18. The method of claim 16, wherein modifying the colors comprises enhancing colors of portions of the at least one intermediate image closer to a viewer relative to colors of portions of the at least one intermediate image farther away from a viewer.

19. The method of claim 16, wherein providing depth information of the scene comprises scanning the scene with a depth scanner.

20. The method of claim 16, wherein providing at least one intermediate image of the scene and providing depth information of the scene comprises capturing at least two intermediate images of the scene with different focus distances, the depth information comprising the focus distances.

21. The method of claim 20, wherein providing the final image comprises combining the at least two intermediate images with modified colors.

22. The method of claim 21, wherein combining the at least two intermediate images comprises focus stacking.

23. The method of claim 20, wherein modifying the colors comprises reducing the colors of an intermediate image of the at least two intermediate images with a greater focus distance relative to the colors of an intermediate image of the at least two intermediate images with a smaller focus distance.

24. The method of claim 20, wherein modifying the colors comprises enhancing the colors of an intermediate image of the at least two intermediate images with a greater focus distance relative to the colors of an intermediate image of the at least two intermediate images with a smaller focus distance.

25. The method of claim 20, wherein capturing the at least two intermediate images comprises capturing the at least two intermediate images with at least two different cameras.

26. A device, comprising:
at least one camera configured to provide an intermediate image of a scene, and
a processor unit configured to modify colors of the at least one intermediate image based on depth information of the scene, and to provide a final image based on the at least one intermediate image with modified colors.

27. The device of claim 26, further comprises a depth scanner configured to provide said depth information.

28. The device of claim 26, wherein the device is configured to capture at least two intermediate images of the scene with said camera with different focus distances, the depth information comprising the focus distances.

29. The device of claim 26, wherein the device is selected from the group consisting of a mobile phone, a digital camera, a laptop computer, a tablet PC, and a gaming device.

30. The device of claim 26, wherein modifying colors of the at least one intermediate image comprises reducing color of portions of the at least one intermediate image further away from a viewer relative to the colors of portions of the at least one intermediate image closer to a viewer.

31. The device of claim 26, wherein modifying the colors comprises enhancing colors of portions of the at least one intermediate image closer to a viewer relative to colors of portions of the at least one intermediate image farther away from a viewer.

32. The device of claim 28, wherein providing the final image comprises combining the at least two intermediate images with modified colors.

33. The device of claim 28, wherein modifying the colors comprises reducing the colors of an intermediate image of the at least two intermediate images with a greater focus distance relative to the colors of an intermediate image of the at least two intermediate images with a smaller focus distance.

34. The device of claim 28, wherein modifying the colors comprises enhancing the colors of an intermediate image of the at least two intermediate images with a greater focus distance relative to the colors of an intermediate image of the at least two intermediate images with a smaller focus distance.

35. The device of claim 26, wherein the at least one camera comprises at least two different cameras configured to capture the at least two intermediate images.
